(19) United States
(12) Patent Application Publication
(10) Pub. No.: US 2009/0206246 A1
(43) Pub. Date: Aug. 20, 2009

(54) Detection Apparatus and Methods

(75) Inventor: William Angus Munro, Watford (GB)

Correspondence Address: FOLEY AND LARDNER LLP;SUITE 500, 3000 K STREET NW, WASHINGTON, DC, 20007, US

(73) Assignee: Smiths Detection-Watford Limited, London (GB)

(21) Appl. No.: 12/227,702

(22) PCT Filed: Jun. 20, 2007
(86) PCT No.: PCT/GB2007/002297

§ 371 Date: Nov. 25, 2008

(30) Foreign Application Priority Data
Jun. 21, 2006 (GB) 0612265.9

(51) Int. Cl. B01D 59/44; H01J 49/00; G01N 30/04

(52) U.S. Cl. 250/282; 250/288; 73/23.42

(57) ABSTRACT

Detection apparatus including an IMS detector (1, 100) or the like has a gas inlet (10) with a gas flow path arrangement (40, 41, 102) by which sample gas is supplied to the detector. In one arrangement two regions (40 and 41) of a gas flow path arrangement are connected in parallel. The regions are provided by respective GC capillary tubing coils (40) and (41) coated internally with materials of different absorption characteristics so that the time taken for the chemical of interest to reach the detector (1) is different along the two coils, thereby giving responses in the detector at different times. Alternatively, two regions of a gas flow path could be provided by regions (104 and 106) arranged serially one after the other.

This invention relates to detection apparatus of the kind including a detection unit having a gas inlet and arranged to detect the presence of certain chemicals in gas supplied to the inlet, the inlet being connected with a gas flow path arrangement along which gas is supplied to the detection unit.

Ion mobility spectrometers are commonly used to detect the presence of, and indicate the nature of, hazardous substances in air. IMSs work effectively for a wide range of hazardous substances but are unable to detect certain substances reliably. Other forms of chemical detector have similar problems.

It is an object of the present invention to provide alternative detection apparatus and methods.

According to one aspect of the present invention there is provided detection apparatus of the above-specified kind, characterised in that the gas flow path arrangement has two regions arranged to affect gas flowing along respective paths differently such that the detection unit provides different responses to gas entering the unit via the two different regions.

The two regions may be arranged in parallel, in two gas flow paths, or serially one after the other along a common gas flow path. The two regions may be arranged to absorb a certain chemical within the gas to different extents so that the presence of that chemical within the gas is indicated by the difference between the response of the detection unit to the gas supplied along the two paths. The two regions preferably contain materials with different absorption characteristics and may be selected from a GC stationary phase, a polymer and a silanized treatment. The gas flow paths may be provided by gas chromatography capillary tubing and the materials may be provided by coatings on the inside of the tubing. The capillary tubing is preferably arranged in a coil. The difference in response may be caused by the difference in the time the chemical takes to pass along the two regions. The detection unit may include an ion mobility spectrometer.

According to another aspect of the present invention there is provided a method of detecting the presence of certain chemicals in a sample gas including the steps of supplying the sample gas along a gas flow path arrangement to the gas inlet of a detection unit, characterised in that the gas flow path arrangement has two regions that have different effects on the certain chemicals, and that an output is provided in response to the gas supplied to the detection unit.

The two regions may be arranged in parallel in two gas flow paths or serially one after the other along a common gas flow path.

Ion mobility spectrometer apparatus and its method of operation, according to the present invention, will now be described, by way of example, with reference to the accompanying drawing, in which:

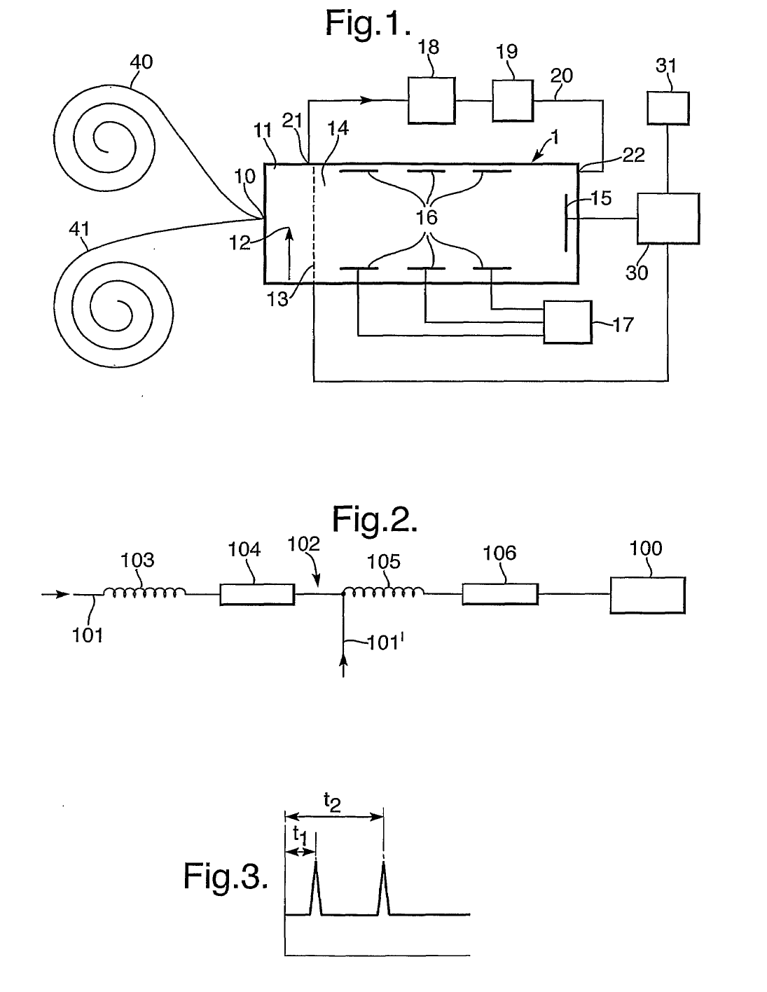

FIG. 1 is a schematic, cross-sectional side elevation view of the apparatus;

FIG. 2 is a schematic view of alternative apparatus; and

FIG. 3 is a graph illustrating the response of the apparatus of FIG. 2.

With reference first to FIG. 1, the apparatus includes a detection unit in the form of a conventional ion mobility spectrometer unit 1 having an inlet 10 by which a sample gas is supplied to the interior of the unit for detection and identification. The inlet 10 opens at the left-hand end of the unit 1 into an ionization region 11 including a corona discharge needle 12 or other arrangement for ionizing the substances within the sample gas. An electrical shutter 13 isolates the ionization region 11 from a drift chamber 14 having a collector plate 15 at its far end, remote from the shutter. Electrodes 16 spaced along the drift chamber 14 are connected to a voltage source 17 so that an electrical field can be established along the drift chamber to cause ion species admitted by the shutter 13 to move from left to right towards the collector plate 15. A pump 18 and molecular sieve 19 are connected in a gas flow path 20 extending from an inlet 21 towards the left-hand end of the unit 1 to an outlet 22 towards the right-hand end of the unit. Cleaned and dried gas flows via the path 20 along the drift chamber 14 from right to left, against the ion flow, in the usual way. The collector plate 15 is connected to a processor 30, which is also connected to control the shutter 13. The processor 30 detects the charge produced when an ion or ion cluster hits the collector plate 15 and computes the time of flight. From this information the nature of many ion species can be identified and an output provided to utilization means, such as a display 31.

The apparatus differs from conventional IMS apparatus in that the inlet 10 connects with a gas flow path arrangement provided by two different gas flow paths 40 and 41 by which gas analyte material is supplied to the IMS unit 1. The two paths 40 and 41 are arranged to have a different effects on predetermined chemicals that would otherwise be difficult for the IMS unit to identify. In particular, the two gas flow paths are provided by two coils of a gas chromatography capillary tubing. Each coil 40 and 41 is coated internally with a different substance. For example, the coil 40 could be coated with a GC stationary phase or a polymer, which is relatively adsorptive of analyte A. The other coil 41 is coated with a less adsorptive material, such as a silanized treatment or a different stationary phase. It can be seen, therefore, that a gas containing the chemical analyte A or a mixture of this chemical with other chemicals will emerge from the downstream end of the two coils 40 and 41 at different times. The open end of each coil 40 and 41 is positioned adjacent one another so that both receive a sample of the same gas. Absorption of the chemical analytea in the coil 40 will also have the effect of delaying passage of the chemical along the coil compared with the less adsorptive coil. The response of the IMS 1 to the gas supplied to it via the two different paths 40 and 41 can be used in various different ways to identify the presence of the selected chemical analytea in a mixture. For example, the time difference between the responses from the two paths could be measured. The time width of the responses from the two paths and the ratio of these responses could be measured. In this way the analyte material can be identified.

The arrangement described above makes use of a gas flow path arrangement with two different regions provided by respective parallel flow paths constituted by the two coils 40 and 41. However, the gas flow path arrangement could have a serial architecture as shown in FIG. 2. In this arrangement a simple detector 100 is used, which has a gas inlet 101, 101′ connected to a gas flow path arrangement indicated generally by the numeral 102. The gas flow path arrangement 102 is provided by a single path with a serial arrangement of a first sample loop 103, a tube 104 containing a Phase 1 absorbent, a second sample loop 105 and a second tube 106 containing a different Phase 2 absorbent. The output end of the second tube 106 is connected to the input of the detector 100. Sample gas is supplied both to the inlet 101 of the first sample loop 103 and directly to the inlet end 101′ of the second sample loop 105. If the gas does not contain the analyte to be detected, the two tubes 104 and 106 and the respective sample loops 103 and 105 will introduce the same time delay to the chemicals within the gas. Assuming the detector 100 is responsive to a chemical within the gas, it will produce two output responses separated in time from one another, as shown in FIG. 3. It can be seen that one response, the first response at time t₁, will be due to gas admitted directly to the second loop 105; the second response at time t₂ , will be due to gas admitted to the first sample loop 103, which is delayed both by the first sample loop and tube 104 and then by the second sample loop 105 and the tube 106, which introduces the same delay as the first loop and tube (assuming there is no adsorption by either tube). It can be seen, therefore, that in this situation:

2 t₁=t₂

where t₁ is the time delay introduced by the second loop and tube and t₂ is the total time delay introduced by both tubes and loops.

However, if the gas supplied to the detector system does contain the selected analyte, this will be delayed to a greater extent by passage through the first tube 104 than by passage through the second tube 106. In this situation, therefore, the following applies:

2 t₁≠t₂

In particular:

2 t₁<t₂

By measuring the time between the responses, therefore, it is possible to determine whether the sample gas contains the analyte or not.

Although the invention is suitable for use with an ion mobility spectrometer it could be used with any other form of detector responsive to the analyte being detected. The detector need not be spectral but could be a non-spectral detector. The detector could be a simple Faraday plate and ion source arrangement. The invention could also be used in apparatus involving liquid phase separations such as LC.

1. Detection apparatus including a detection unit having a gas inlet and arranged to detect the presence of certain chemicals in gas supplied to the inlet, the inlet being connected with a gas flow path arrangement along which gas is supplied to the detection unit, wherein the gas flow path arrangement has two regions arranged to affect gas flowing along respective paths differently such that the detection unit provides different responses to gas entering the unit via the two different regions.

2. Detection apparatus according to claim 1, wherein the two regions are arranged in parallel in two gas flow paths.

3. Detection apparatus according to claim 1, wherein the two regions are arranged serially one after the other along a common gas flow path.

4. Detection apparatus according to claim 1, wherein the two regions are arranged to absorb a certain chemical within the gas to different extents so that the presence of that chemical within the gas is indicated by the difference between the response of the detection unit to the gas supplied along the two paths.

5. Detection apparatus according to claim 4, wherein the two regions contain two materials with different absorption characteristics.

6. Detection apparatus according to claim 5, wherein the materials are selected from a GC stationary phase, a polymer and a silanized treatment.

7. Detection apparatus according to claim 1, wherein the gas flow paths are provided by gas chromatography capillary tubing.

8. Detection apparatus according to claim 7, wherein the materials are provided by coatings on the inside of the tubing.

9. Detection apparatus according to claim 7, wherein the capillary tubing is arranged in a coil.

10. Detection apparatus according claim 1, wherein the difference in response is caused by the difference in time the chemical takes to pass along the two regions.

11. Detection apparatus according claim 1, wherein the detection unit includes an ion mobility spectrometer.

12. A method of detecting the presence of certain chemicals in a sample gas including the steps of supplying the sample gas along a gas flow path arrangement to the gas inlet of a detection unit , wherein the gas flow path arrangement has two regions that have different effects on the certain chemicals, and that an output is provided in response to the gas supplied to the detection unit.

13. A method according to claim 12, wherein the two regions are arranged in parallel in two gas flow paths.

14. A method according to claim 12, wherein the two regions are arranged serially one after the other along a common gas flow path.
